(19) United States
(12) Patent Application Publication
(10) Pub. No.: US 2015/0029422 A1
(43) Pub. Date: Jan. 29, 2015

(54) TOUCH PANEL AND TOUCH DISPLAY PANEL

(71) Applicant: WINTEK CORPORATION, Taichung City (TW)

(72) Inventors: Ting-Yu Chang, Kaohsiung City (TW); Chong-Wei Li, Changhua County (TW); Kuo-Chang Su, Taichung City (TW); Ching-Fu Hsu, Taichung City (TW); Siang-Lin Huang, Taichung City (TW)

(21) Appl. No.: 14/445,087

(22) Filed: Jul. 29, 2014

(30) Foreign Application Priority Data
Jul. 29, 2013 (TW) 102214211

(51) Int. Cl. G06F 3/041

(52) U.S. Cl. CPC G06F 3/0412
USPC 349/12

(57) ABSTRACT

The present invention provides a touch panel and a touch display panel including an insulating layer, a first conductive pattern, and a second conductive pattern. The first conductive pattern and the second conductive pattern are respectively disposed on two sides of the insulating layer. The first conductive pattern includes a plurality of first electrode strips, wherein each first electrode strip includes a strip portion and a plurality of protrusion portions protruding from two sides of the strip portion. The second conductive pattern includes a plurality of second electrode strips, crossing the first electrode strips.

### BACKGROUND OF THE INVENTION

1. Field of the Invention

The present invention relates to a touch panel and a touch display panel.

2. Description of the Prior Art

Because of the intelligent characteristics of human-computer interaction, touch panels have been widely applied to the external input interfaces of many electronic products. In recent years, as the applications of electronic products have developed diversely, consumer electronics with the integration of touch sensing functions and display panels are commercialized a lot and have evolved flourishingly, for example, mobile phones, GPS navigator system, tablet PCs, PDA and laptop PCs.

Traditional touch panel includes a plurality of first sensing electrode strips and a plurality of second sensing electrode strips, and first sensing electrode strips cross the second sensing electrode strips, so that each first sensing electrode strip and each second sensing electrode strip form a coupling capacitor therebetween. Also, driving signals are transferred to the first sensing electrode strips sequentially respectively, and sensing signals are sequentially detected by the second sensing electrode strips. When no finger touches the touch panel, the total capacitance of each coupling capacitor can be obtained. Also, when the finger touches the touch panel, the total capacitance of each coupling capacitor near the finger will be changed accordingly. Thus, the touch panel can recognize the position of the finger.

However, since the capacitance formed by an overlapping part of each first sensing electrode strip and each second sensing electrode strip is stored between each first sensing electrode strip and each second sensing electrode strip, the capacitance formed by each overlapping part is not easy to be changed by the touch of the finger when the finger touches the touch panel. Also, in the traditional touch panel, the capacitance of the overlapping part between each first sensing electrode strip and each second sensing electrode strip occupies a large proportion of the total capacitance of each coupling capacitor, but the capacitance variance of each overlapping part only occupies a small proportion of the total capacitance of each coupling capacitor, thereby limiting the touch sensitivity of the traditional touch panel.

Therefore, to increase the capacitance variance of each coupling capacitor to raise the touch sensitivity of the touch panel is an important objective in this field.

### SUMMARY OF THE INVENTION

It is therefore an objective of the present invention to provide a touch panel and a touch display panel to raise the touch sensitivity.

According to an embodiment of the present invention, a touch panel is disclosed. The touch panel includes a first insulating layer, a first conductive pattern, and a second conductive pattern. The first insulating layer has a first side and a second side opposite to each other. The first conductive pattern is disposed on the first side of the first insulating layer, and the first conductive pattern includes a plurality of first electrode strips sequentially arranged along a first direction, wherein each first electrode strip comprises a strip portion and a plurality of protrusion portions, the protrusion portions are protruded from two sides of each strip portion and along the first direction. The second conductive pattern is disposed on the second side of the first insulating layer, and the second conductive pattern includes a plurality of second electrode strips, wherein the second electrode strips are arranged along a second direction different from the first direction and cross the first electrode strips.

According to another embodiment of the present invention, a touch display panel is further disclosed. The touch display panel includes a touch panel and a display panel. The touch panel includes a first insulating layer, a first conductive pattern, and a second conductive pattern. The first insulating layer has a first side and a second side opposite to each other. The first conductive pattern is disposed on the first side of the first insulating layer, and the first conductive pattern includes a plurality of first electrode strips sequentially arranged along a first direction and a plurality of shielding patterns, wherein each first electrode strip comprises a strip portion and a plurality of protrusion portions, the protrusion portions are protruded from two sides of each strip portion and along the first direction, and each shielding pattern is respectively disposed between any two of the protrusion portion near each other and at each side of each strip portion. The second conductive pattern is disposed on the second side of the first insulating layer, and the second conductive pattern includes a plurality of second electrode strips, wherein the second electrode strips are arranged along a second direction different from the first direction and cross the first electrode strips, and the shielding patterns overlap the second conductive pattern in a third direction perpendicular to the first insulating layer. The display panel is disposed on the first side of the first insulating layer.

According to another embodiment of the present invention, a touch display panel is further disclosed. The touch display panel includes a display panel, and a second conductive pattern. The display panel includes a top substrate and a first conductive pattern, wherein the top substrate has an outer surface and an inner surface, the first conductive pattern is disposed on the inner surface of the top substrate, and the first conductive pattern comprises a plurality of first electrode strips sequentially arranged along a first direction and a plurality of shielding patterns, wherein each first electrode strip comprises a strip portion and a plurality of protrusion portions, the protrusion portions are protruded from two sides of each strip portion along the first direction respectively, and each shielding pattern is disposed between any two of the protrusion portions near each other and at each side of each strip portion. The second conductive pattern is disposed on the outer surface of the top substrate, and the second conductive pattern includes a plurality of second electrode strips, wherein the second electrode strips are sequentially arranged along a second direction different from the first direction and cross the first electrode strips, and the shielding patterns overlap the second conductive pattern in a third direction perpendicular to the first insulating layer.

According to another embodiment of the present invention, a touch panel is further disclosed. The touch panel includes a first insulating layer, a first conductive pattern, and a second conductive pattern. The first insulating layer has a first side and a second side opposite to each other. The first conductive pattern is disposed on the first side of the first insulating layer, and the first conductive pattern includes a plurality of first electrode strips sequentially arranged along a first direction, wherein each first electrode strip comprises a plurality of openings arranged in a matrix formation. The second conductive pattern is disposed on the second side of the first insulating layer, and the second conductive pattern includes a plurality of second electrode strips, wherein the second electrode strips are arranged along a second direction different from the first direction and cross the first electrode strips.

According to another embodiment of the present invention, a touch display panel is further disclosed. The touch display panel includes a touch panel and a display panel. The touch panel includes a first insulating layer, a first conductive pattern, and a second conductive pattern. The first insulating layer has a first side and a second side opposite to each other. The first conductive pattern is disposed on the first side of the first insulating layer, and the first conductive pattern includes a plurality of first electrode strips sequentially arranged along a first direction and a plurality of shielding patterns, wherein each first electrode strip comprises a plurality of openings arranged in a matrix formation, and each shielding pattern is disposed in each opening respectively. The second conductive pattern is disposed on the second side of the first insulating layer, and the second conductive pattern includes a plurality of second electrode strips, wherein the second electrode strips are arranged along a second direction different from the first direction and cross the first electrode strips, and the shielding patterns overlap the second conductive pattern in a third direction perpendicular to the first insulating layer. The display panel is disposed on the first side of the first insulating layer.

According to another embodiment of the present invention, a touch display panel is further disclosed. The touch display panel includes a display panel and a second conductive pattern. The display panel includes a top substrate and a first conductive pattern, wherein the top substrate has an outer surface and an inner surface, the first conductive pattern is disposed on the inner surface of the top substrate, and the first conductive pattern comprises a plurality of first electrode strips sequentially arranged along a first direction and a plurality of shielding patterns, wherein each first electrode strip comprises a plurality of openings arranged in a matrix formation, and each shielding pattern is disposed in each opening respectively. The second conductive pattern is disposed on the outer surface of the top substrate, and the second conductive pattern includes a plurality of second electrode strips, wherein the second electrode strips are sequentially arranged along a second direction different from the first direction and cross the first electrode strips, and the shielding patterns overlap the second conductive pattern in a third direction perpendicular to the first insulating layer.

In the touch panel of the present invention, the fringe capacitance between each first electrode strip and each second electrode strip may be increased by increasing the lengths of the sides of each first electrode strip near each second electrode strip or increasing the lengths of the sides of each second electrode strip near each first electrode strip. Also, in the touch panel of the present invention, the shielding patterns are disposed to prevent the second electrode strips from being interfered by the display panel and to compensate the refractive index of the touch panel at the region of the concavities or the openings. Accordingly, the visual difference of the touch panel can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch display panel according to a first embodiment of the present invention.

FIG. 2 is a schematic diagram illustrating a top view of the first conductive pattern of the touch panel according to the first embodiment of the present invention.

FIG. 3 is a schematic diagram illustrating a top view of the first conductive pattern and the second conductive pattern according to the first embodiment of the present invention.

FIG. 4 is a schematic diagram illustrating electric field lines between the first electrode strips and the second electrode strips.

FIG. 5 is a schematic diagram illustrating a top view of a touch panel according to a second embodiment of the present invention.

FIG. 6 is a schematic diagram illustrating a top view of a first conductive pattern according to a second embodiment of the present invention.

FIG. 7 is a schematic diagram illustrating a top view of a touch panel according to a third embodiment of the present invention.

FIG. 8 is a schematic diagram illustrating a top view of a first conductive pattern according to a third embodiment of the present invention.

FIG. 9 is a schematic diagram illustrating a cross-sectional view of a touch panel according to a fourth embodiment of the present invention.

FIG. 10 is a schematic diagram illustrating a cross-sectional view of a touch panel according to a fifth embodiment of the present invention.

FIG. 11 is a schematic diagram illustrating a cross-sectional view of a touch panel according to a sixth embodiment of the present invention.

FIG. 12 is a schematic diagram illustrating a cross-sectional view of a touch display panel according to a seventh embodiment of the present invention.

FIG. 13 is a schematic diagram illustrating a cross-sectional view of a touch display panel according to an eighth embodiment of the present invention.

FIG. 14 is a schematic diagram illustrating a cross-sectional view of a touch panel according to a ninth embodiment of the present invention.

### DETAILED DESCRIPTION

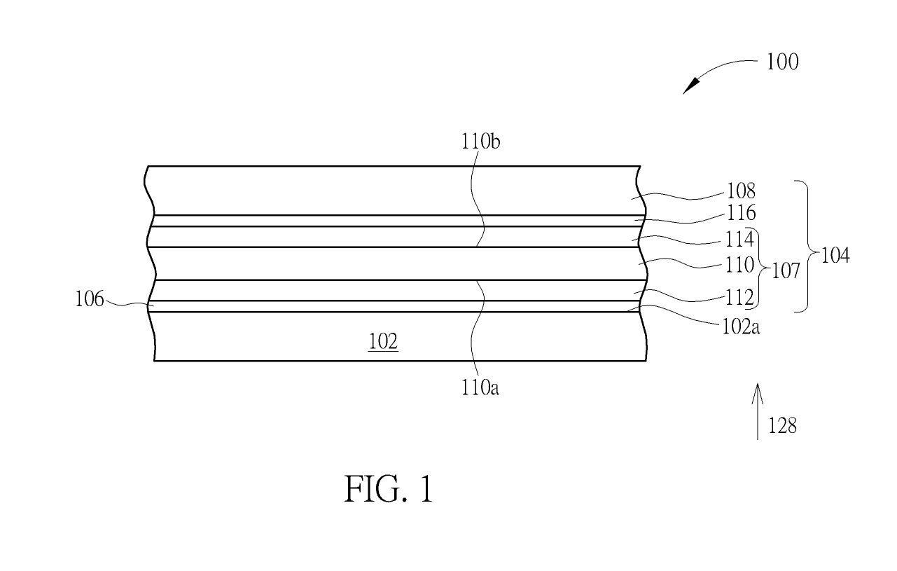

Referring to FIG. 1, FIG. 1 is a schematic diagram illustrating a touch display panel according to a first embodiment of the present invention. As shown in FIG. 1, the touch display panel 100 of this embodiment includes a display panel 102, a touch panel 104, and a first adhesive layer 106. The display panel 102 has a display surface 102a used for displaying an image, and the touch panel 104 is disposed on the display surface 102a and used to detect a position of the touch display panel 100 being touched by the touch object. The first adhesive layer 106 is disposed between the touch panel 104 and the display panel 102 and used to combine the touch panel 104 and the display panel 102. The display panel 102 may include a liquid crystal panel, an organic light-emitting diode display panel, an electrowetting display panel, an electronic paper display panel or a plasma display panel, but the present invention is not limited thereto. In this embodiment, the touch panel 104 includes a touch sensing structure 107 and a transparent substrate 108. The touch sensing structure 107 includes a first insulating layer 110, a first conductive pattern 112, and a second conductive pattern 114. The transparent substrate 108 is a transparent cover plate. One surface of the transparent cover plate may be used to be touched by the touch object so as to perform a function. The transparent substrate 108 maybe, for example, a glass substrate, a quartz substrate, sapphire substrate or a plastic substrate, but the present invention is not limited thereto. The first insulating layer 110 has a first side 110a and a second side 110b opposite to each other. The display panel 102 is disposed at one side of the touch panel 104, such as the first side 110a of the first insulating layer 110, and the transparent substrate 108 is disposed on the second side 110b of the first insulating layer 110. The first insulating layer 110 may include, for example, a transparent insulating film, a transparent insulating plastic substrate or a transparent insulating glass substrate, an organic insulating layer or an inorganic insulating layer, but the present invention is not limited thereto. In addition, the first conductive pattern 112 is formed and disposed on the first side 110a of the first insulating layer 110, and the second conductive pattern 114 is formed and disposed on the second side 110b of the first insulating layer 110; or, only an overlapping region between the first conductive pattern 112 and the second conductive pattern 114 may have the first insulating layer 110 disposed between the first conductive pattern 112 and the second conductive pattern 114. The first conductive pattern 112 and the second conductive pattern 114 may include a transparent conductive material, such as indium tin oxide, indium zinc oxide, or metal mesh. The metal mesh may include an opaque metal material or a metal material having an enough thinness to allow light penetrating there through, but the present invention is not limited to this. As we can see from the above-mentioned description, the touch panel 104 of this embodiment has double side conductive layer structure. Also, the touch panel 104 of this embodiment includes a second adhesive layer 116 disposed between the touch structure 107 and the transparent substrate 108 and used to combine the touch sensing structure 107 and the transparent substrate 108.

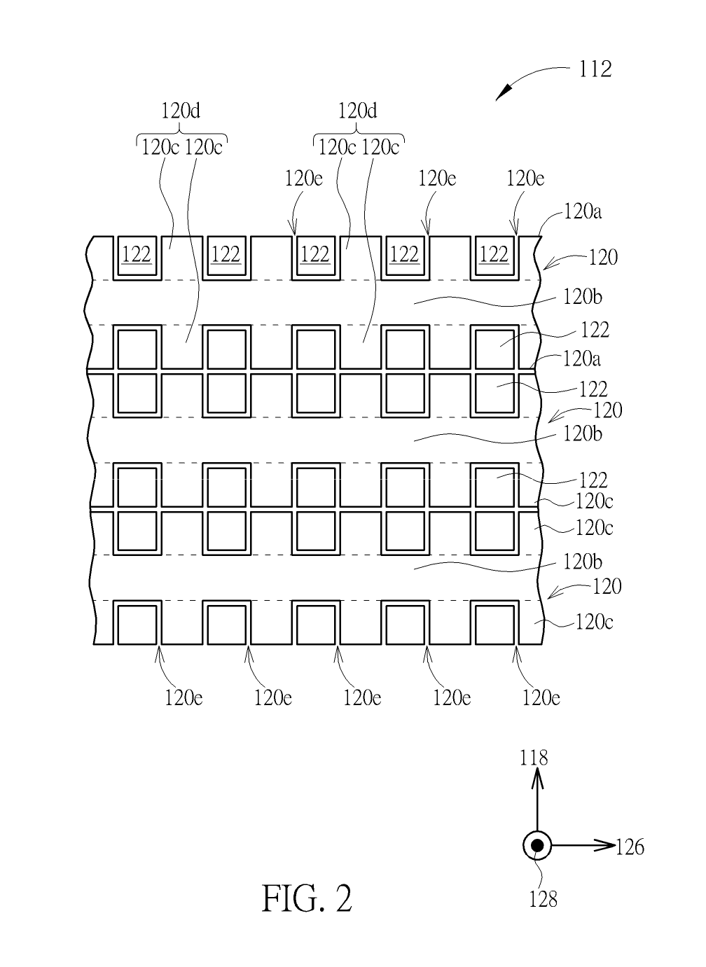

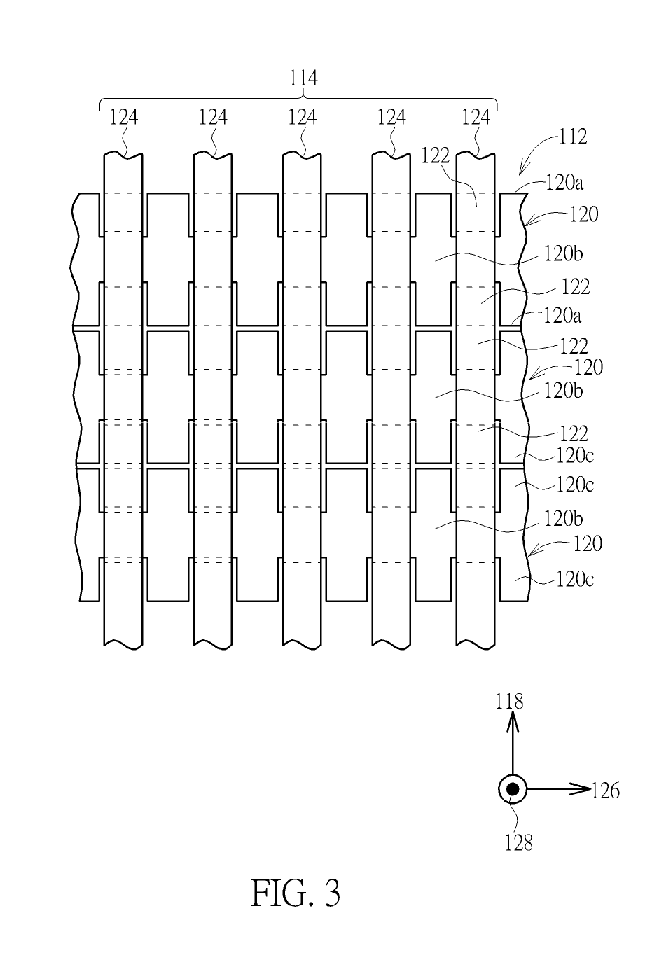

The following description will further detail the touch panel of this embodiment. Referring to FIG. 2 and FIG. 3 and referring FIG. 1, FIG. 2 is a schematic diagram illustrating a top view of the first conductive pattern of the touch panel according to the first embodiment of the present invention, and FIG. 3 is a schematic diagram illustrating a top view of the first conductive pattern and the second conductive pattern according to the first embodiment of the present invention. As shown in FIG. 1 and FIG. 2, the first conductive pattern 112 includes a plurality of first electrode strips 120 sequentially arranged along a first direction 118, and a plurality of shielding pattern 122. Specifically, each first electrode strip 120 may include a strip portion 120b and a plurality of protrusion portions 120c. The strip portions 120b extend along a second direction 126 different from the first direction 118, for example, a direction perpendicular to the first direction 118, and the protrusion portions 120c of each first electrode strip 120 are protruded from two sides of each strip portions 120 respectively, thereby the two opposite sides 120a of each first electrode strip 120 are not flat. In other words, any two of the protrusion portions 120c near each other and disposed at each side of each strip portion 120b and each strip portion 120b may form a concavity 120e. In this embodiment, the protrusion portions 120c of each first electrode strip 120 may include a plurality of first protrusion portion 120c and a plurality of second protrusion portion 120c disposed at the two sides of each strip portion 120b respectively and symmetrical to each strip portion 120b. Furthermore, each first protrusion portion 120c and each second protrusion portion 120c of each first electrode strip 120 disposed at the two sides of the strip portion 120b respectively and symmetrical to each strip portion 120b may form a protrusion pair 120d. There is a gap between any two of the protrusion pairs 120d of different first electrode strips 120 near each other, and the gaps are the same. The protrusion pairs 120d of each first electrode strip 120 are arranged sequentially along the second direction 126, and the protrusion pairs 120d of different first electrode strips 120 are arranged sequentially along the first direction 118. Each protrusion portion 120c may be rectangular; each first electrode strip 120 may be palisade-shaped; and each concavity 120e is rectangular, but the present invention is not limited thereto. In other embodiments of the present invention, a protruding surface of each protrusion portion also may be curved shape or other shapes. Also, each concavity may be other shapes, such as arc or other shapes.

Furthermore, each shielding pattern 122 is disposed between any two of the protrusion portions 120c near each other and at each side of each strip portion 120b, and each shielding pattern 122 is not in contact with the strip portion 120b and the protrusion portions 120c adjacent thereto. Namely, each shielding pattern 122 is disposed in each concavity 120e respectively, and there is a gap between each shielding pattern 122 and the first electrode strip 120 near thereto. Accordingly, the shielding patterns 122 may be electrically insulated from each first electrode strip 120. In this embodiment, the shielding patterns 122 are electrically floating, but the present invention is not limited thereto. In other embodiments of the present invention, the shielding patterns may be electrically connected to a ground.

Also, as shown in FIG. 3, the second conductive pattern 114 includes a plurality of second electrode strips 124. The second electrode strips 124 are arranged sequentially along the second direction 126 and cross the first electrode strips 112. Specifically, each second electrode strip 124 cross the strip portions 120b of the first electrode strips 120 and is disposed between any two of the protrusion portions 120c of each first electrode strip 120 in a third direction 128 perpendicular to the first direction 118 and the second direction 126. This is to say that each second electrode strip 124 is disposed between any two of the protrusion pairs 120d of each first electrode strip 120. Accordingly, each second electrode strip 124 only overlaps the strip portion 120b of each first electrode strip 120. In this embodiment, each second electrode strip 114 has two flat sides, and is a strip-shaped electrode, but the present invention is not limited thereto. It should be noted that each second electrode strip 124 may be coupled with the sides of the protrusion portions 120c adjacent thereto and facing this second electrode strip 124 so as to generate a fringe capacitor. In comparison with the sensing electrode strips in the prior art, each first electrode strip 120 of this embodiment has protrusion portions 120c, so that a length of a side 120a of each first electrode strip 120 coupled with each second electrode strip 124 is longer. In other words, each first electrode strip 120 further has the extra sides of the protrusion portions 120c near each second electrode strip 124. Thus, in this embodiment, the capacitances of the fringe capacitors generated from the sides of the protrusion pairs 120c of each first electrode strip 120 coupled with the sides of each second electrode strip 124 can be effectively increased, thereby raising the touch sensitivity of the touch panel 104.

Also, please noted that since the shielding patterns 122 overlap the second conductive pattern 114 in the third direction 128, the shielding patterns 122 may be disposed between the display panel 102 and the second conductive pattern 114, thereby electrically shielding and isolating an electric field of the display panel 102 from applying to the second electrode strips 124. Accordingly, the signals transferred in the second electrode strips 124 can be prevented from being interfered by the display panel 102. Also, since each shielding pattern 122 is disposed between any two of protrusion portions 120c near each other and arranged in the second direction 126, which means each shielding pattern 122 is disposed in each concavity 120e, the refractive index of a part of the touch panel 104 at the concavities 120e may be compensated. Accordingly, the touch panel 104 may have uniform refractive index, thereby improving the visual performance of the touch panel 104. Also, the gap between each shielding pattern 122 and each first electrode strip 120 is preferably as small as possible.

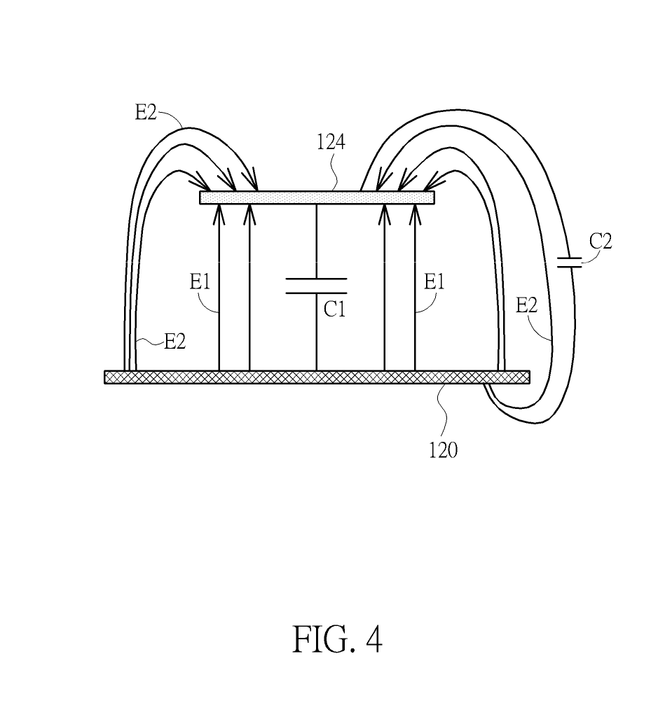

The following description will further detail the influence of each fringe capacitor on the touch sensitivity. Referring to FIG. 4 together with FIG. 2, FIG. 4 is a schematic diagram illustrating electric field lines between the first electrode strips and the second electrode strips. As shown in FIG. 2 and FIG. 4, a total capacitance between each first electrode strip 120 and each second electrode strip 124 includes a capacitance of a capacitor C1 generated by an overlapping part between each first electrode strip 120 and each second electrode strip 124 and a capacitance of a fringe capacitor C2 generated from the sides of each first electrode strip 120 and the sides of each second electrode strip 124. It should be noted that the electric field lines E1 of the capacitor C1 of the overlapping part are generated between each first electrode strip 120 and each second electrode strip 124 and shielded by each second electrode strip 124. The electric field lines E2 of the fringe capacitor C2 will extend onto each second electrode strip 122. Accordingly, when the touch object touch the touch panel 104, the capacitor C1 of the overlapping part is shielded by the second electrode strips 124, so that the capacitor C1 is not easily changed by the touch object. But, the electric field lines E2 are easily attracted and changed by the touch object. Thus, when the fringe capacitors C2 of the touch panel 104 are increased, the difference between the total capacitances before and after the touch panel 104 being touched can be effectively raised. For this reason, the touch panel 104 easily detects the change of the fringe capacitor C2, thereby raising the touch sensitivity.

The touch panel of the present invention is not limited to the above-mentioned embodiment. The following description continues to detail the other embodiments or modifications, and in order to simplify and show the difference between the other embodiments or modifications and the above-mentioned embodiment, the same numerals denote the same components in the following description, and the same parts are not detailed redundantly.

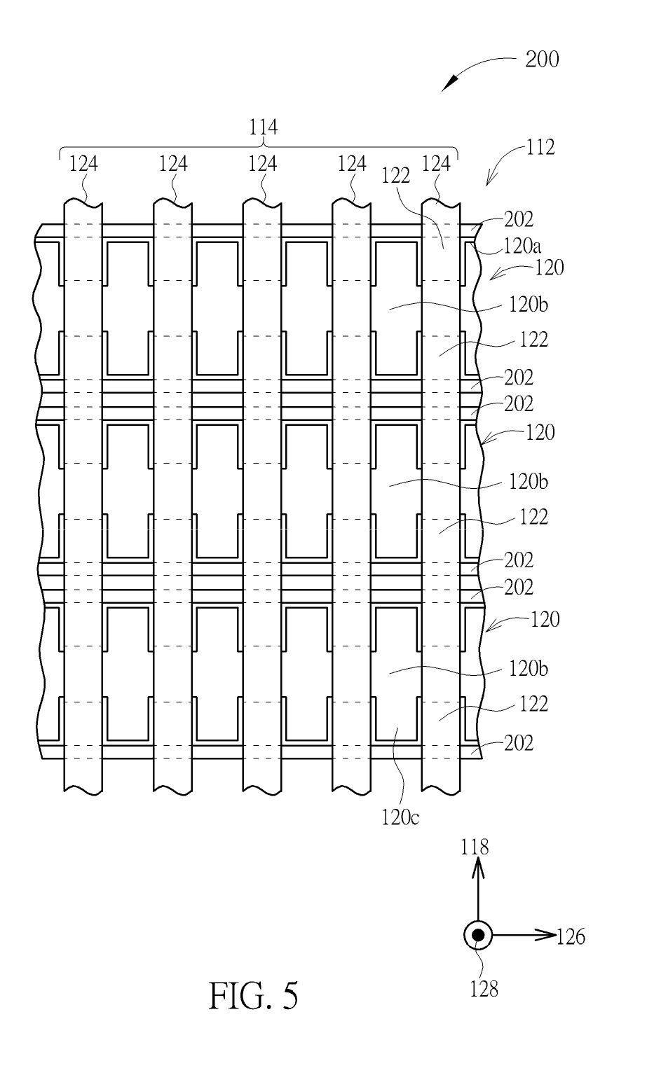

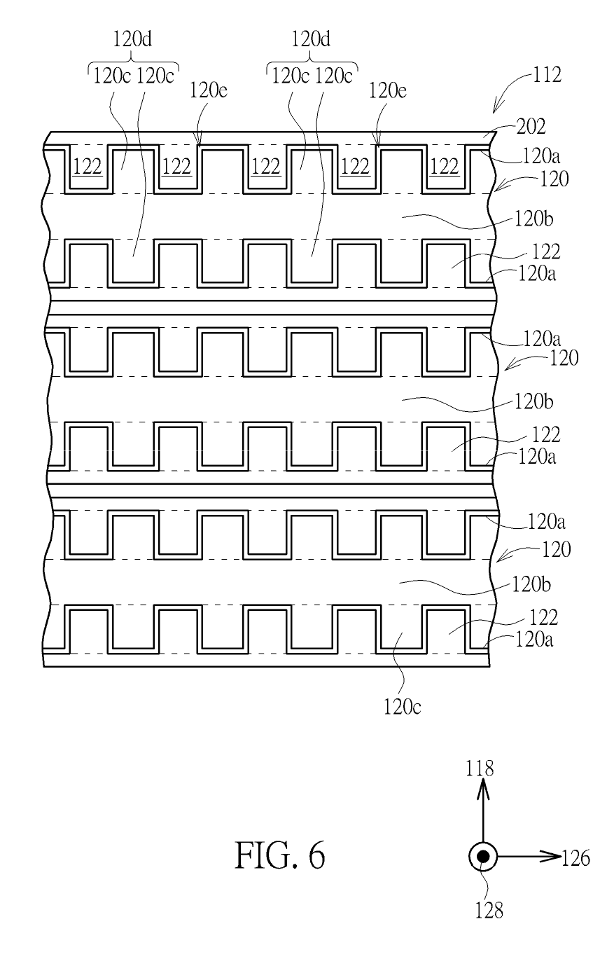

Referring to FIG. 5 and FIG. 6, FIG. 5 is a schematic diagram illustrating a top view of a touch panel according to a second embodiment of the present invention, and FIG. 6 is a schematic diagram illustrating a top view of a first conductive pattern according to a second embodiment of the present invention. As shown in FIG. 5 and FIG. 6, in comparison with first embodiment, the first conductive pattern 112 of the touch panel 200 of this embodiment further includes a plurality of connecting patterns 202. In this embodiment, each connecting pattern 202 may be strip-shaped, and sequentially arranged along a first direction 118, but the present invention is not limited thereto. Also, each connecting pattern 202 is disposed near a side of each first electrode strip 120. This is to say that any two of the connecting patterns 202 near each other are disposed between any two of the first electrode strips 120 near each other. Furthermore, each connecting pattern 202 is connected to the shield patterns 122 at each side of each strip portion 120b. Accordingly, the connecting patterns 202 may electrically connect the shielding patterns 122 to one another and may be electrically connected to the ground. The present invention is not limited thereto. In other embodiments of the present invention, the connecting patterns also maybe floating. In addition, each connecting pattern 202 and the shielding patterns 122 connected thereto are preferably formed monolithically. Also, the connecting patterns 202 and the first conductive pattern 112 may be formed by the same material, but the present invention is not limited thereto.

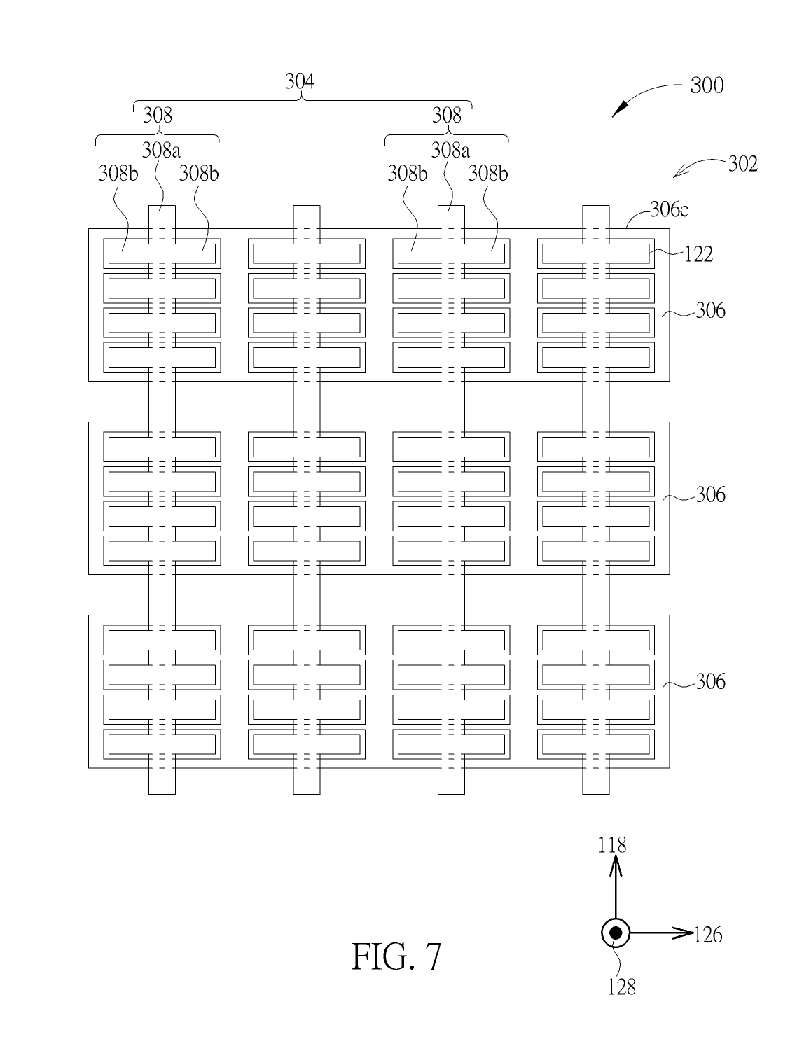

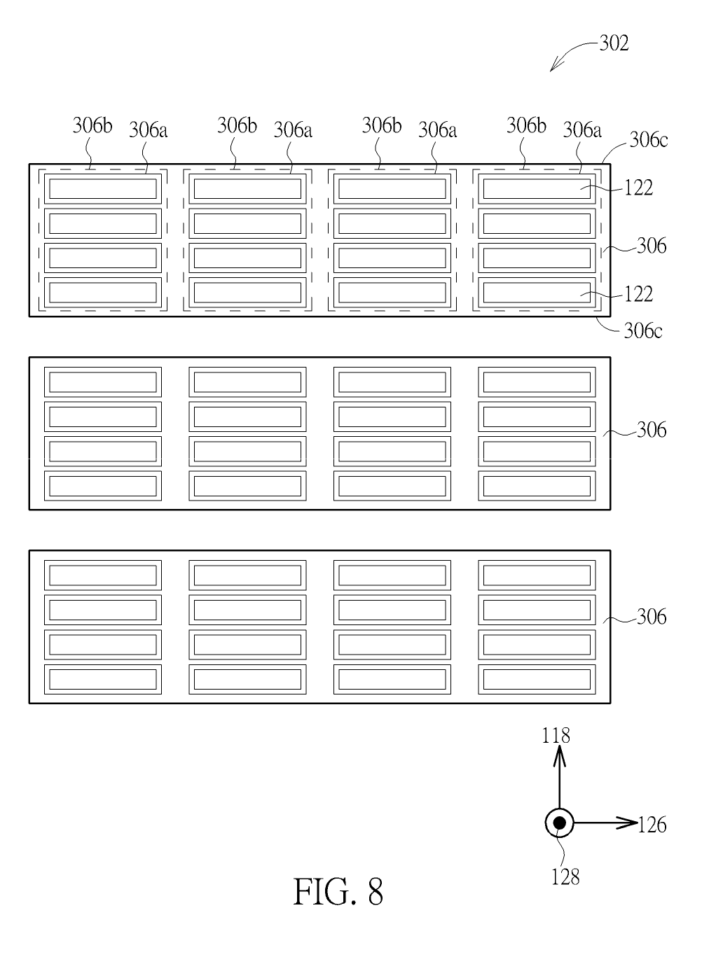

Referring to FIG. 7 and FIG. 8, FIG. 7 is a schematic diagram illustrating a top view of a touch panel according to a third embodiment of the present invention, and FIG. 8 is a schematic diagram illustrating a top view of a first conductive pattern according to a third embodiment of the present invention. As shown in FIG. 7 and FIG. 8, the first conductive pattern 302 and the second conductive pattern 304 of the touch panel 300 of this embodiment are different from the first conductive pattern and the second conductive pattern of the first embodiment. The difference between this embodiment and the first embodiment is that each first electrode strip 306 has a plurality of openings 306a respectively in this embodiment. Specifically, each first electrode strip 306 may include a plurality of opening portions 306b, wherein the opening portions 306b in the same first electrode strip 306 are arranged sequentially along the second direction 126, and the opening portions 306b in different first electrode strips 306 are arranged sequentially along the first direction 118. Accordingly, the opening portions 306b may be arranged in a matrix formation. Each second electrode strip 308 is disposed corresponding to the opening portions 306b respectively indifferent first electrode strips 306, which means the opening portions 306b in a same column are disposed corresponding to the same second electrode strip 308, thereby each second electrode strip 308 crossing the opening portions 306b in the same column. Each opening portion 306b may have four openings 306a arranged along the first direction 118, and the openings 306a are arranged in a matrix formation also. The number of the openings 306a of each opening portion 306b in the present invention is not limited thereto, and may be at least one. Moreover, each shielding pattern 122 is disposed in each opening 306a respectively. Two sides 306c of each first electrode strip 306 may be flat sides, but the present invention is not limited herein. The sides of each first electrode strip may be the same as that of the above-mentioned embodiments. In this embodiment, the shielding patterns 122 are electrically floating, but the present invention is not limited thereto. In other embodiments, the shielding patterns may also be electrically connected to the ground.

Furthermore, each second electrode strip 308 may include a strip portion 308a and a plurality of protrusion portions 308b, and the protrusion portions 308b extend from two sides of each strip portion 308a along the second direction 126. Accordingly, each strip portion 308a and the protrusion portions 308b of each second electrode strip 308 form a plurality of palisade-shaped structures, in which each palisade-shaped structure of each second electrode strip 308 is disposed corresponding to each first electrode strip 306. Specifically, each strip portion 308a cross the opening portions 306b respectively in the first electrode strips 306. Namely, each strip portion 308a crosses the openings 306a in the same column and overlaps a part of each opening portion 306b of each first electrode strip 306 in the third direction 128. Also, the protrusion portions 308b of each second electrode strip 308 may include first protrusion portions 308b and second protrusion portions 308b disposed at two sides of the each strip portion 308a respectively, and each first protrusion portion 308b and each second protrusion portion 308b are symmetrical to each strip portion 308a. Further, the protrusion portions 308b extending from each strip portion 308a overlap the shielding patterns 122 in the same column respectively. In other words, a width of a part of each second electrode strip 308 without overlapping the shielding patterns 122 along the second direction 126 is smaller than a width of the other part of each second electrode strip overlapping each shielding pattern 122 along the second direction 126. Thus, in the touch panel 300 of this embodiment, the fringe capacitance between each second electrode strip 308 and each first electrode strip 306 may be increased by the part of each opening 306a of each first electrode strip 306 without overlapping each second electrode strip 308 and each protrusion portion 308b of each second electrode strip 308, thereby increasing the touch sensitivity of the touch panel 300. In the touch panel 300 of this embodiment, the shielding patterns 122 are disposed to prevent the second electrode strips 308 from being interfered by the display panel 102 and to compensate the refractive index of the touch panel 300 at the region of the openings 106a. Accordingly, the visual difference between the first electrode strips 306 and the openings 306a can be reduced. Also, the gaps between the shielding patterns 122 and the first electrode strips 306 are preferably as small as possible. In other embodiments of the present invention, the protrusion portions at two sides of each strip portion of each second electrode strip also may not be symmetrical to each strip portion.

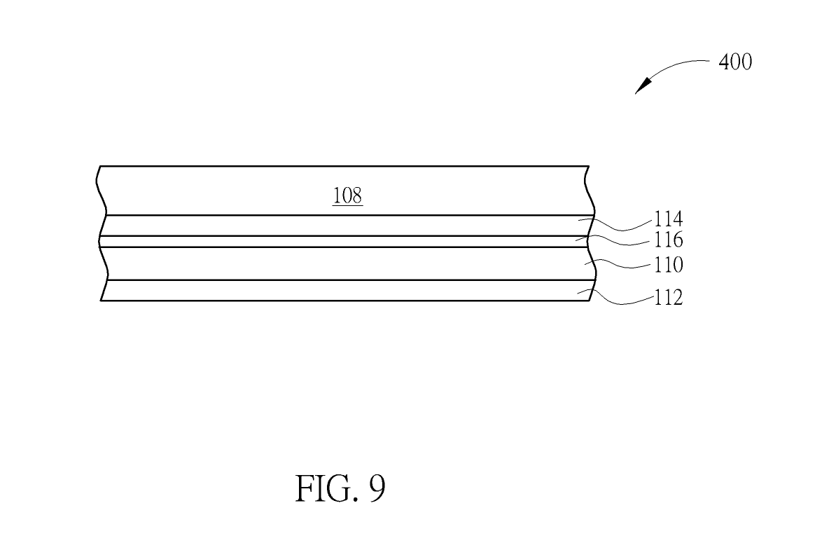

Referring to FIG. 9, FIG. 9 is a schematic diagram illustrating a cross-sectional view of a touch panel according to a fourth embodiment of the present invention. As shown in FIG. 9 in comparison with the first embodiment, the second adhesive layer 116 of the touch panel 400 of this embodiment is disposed between the second conductive pattern 114 and the first insulating layer 110. This is to say that the second conductive pattern 114 is directly formed on the transparent substrate 108, and the second conductive pattern 114 may be combined with the first insulating layer 110 through the second adhesive layer 116. Furthermore, the first conductive pattern 112 also may be disposed on a top surface of the first insulating layer 110, in which the top surface is a surface facing the second conductive pattern 114.

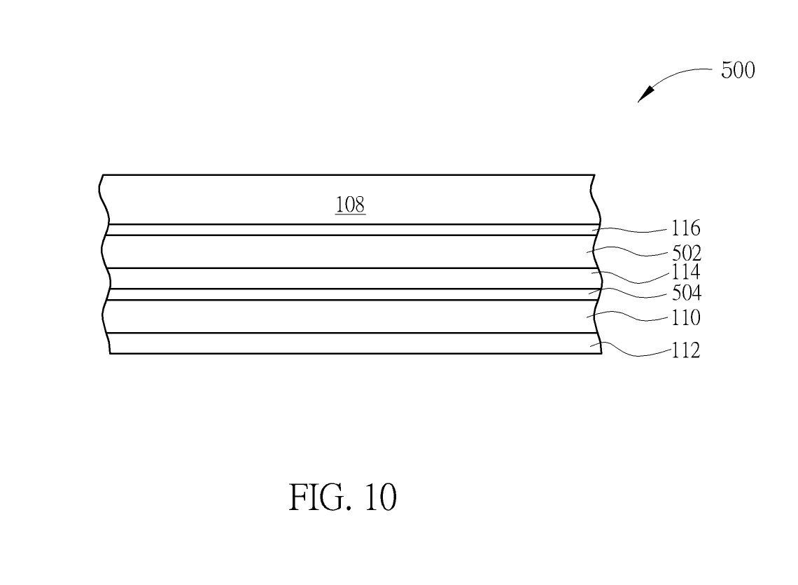

Referring to FIG. 10, FIG. 10 is a schematic diagram illustrating a cross-sectional view of a touch panel according to a fifth embodiment of the present invention. As shown in FIG. 10, in comparison with the first embodiment, the touch panel 500 of this embodiment further includes a second insulating layer 502 and a third adhesive layer 504. The second insulating layer 502 is disposed between the second conductive pattern 114 and the transparent substrate 108, and the second conductive pattern 114 is directly formed on the second insulating layer 502. The second adhesive layer 116 is disposed between the second insulating layer 502 and the transparent substrate 108 and used to combine the second insulating layer 502 and the transparent substrate 108. The first insulating layer 110 and the second insulating layer 502 may be made from, for example, a transparent insulating film, a transparent insulating plastic substrate or a transparent insulating glass substrate, but the present invention is not limited thereto. Specifically, the first insulating layer 110 and the second insulating layer 502 may be supporting layers for respectively support the first conductive pattern 112 and the second conductive pattern 114. The matrix of the aforementioned supporting layer is polyimide. In one alternative embodiment, the supporting layer may be added with other organic or inorganic material except polyimide such as SiOx and/or SiNx for enhancing chemical resistance and optical characteristic. Also, the third adhesive layer 504 is disposed between the second conductive pattern 114 and the first insulating layer 110 and used to combine the second conductive pattern 114 and the first insulating layer 110.

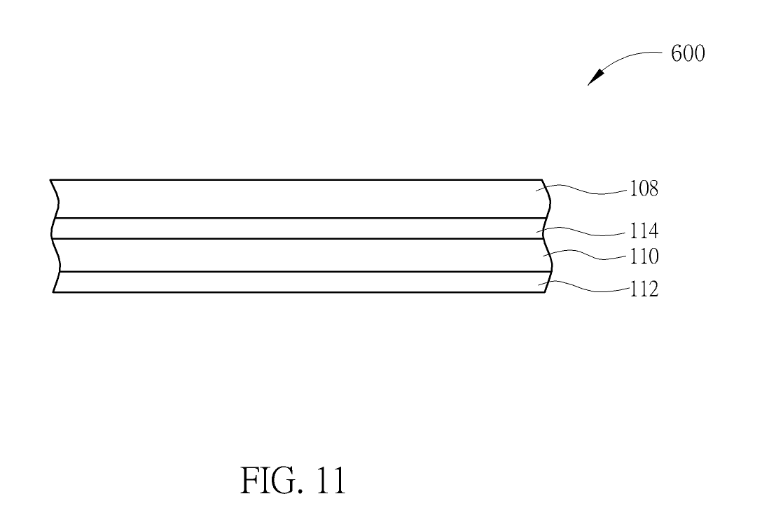

Referring to FIG. 11, FIG. 11 is a schematic diagram illustrating a cross-sectional view of a touch panel according to a sixth embodiment of the present invention. As shown in FIG. 11, in comparison with first embodiment, the second adhesive layer is omitted in the touch panel 600 of this embodiment. In other words, the second conductive pattern 114, the first insulating layer 110 and the first conductive pattern 112 are sequentially formed on the transparent substrate 108 in this embodiment, so no second adhesive layer is required to combine the first insulating layer 110 to the transparent substrate 108. Furthermore, a decoration layer (not shown in the figures) may be optionally formed at the periphery of the transparent substrate 108 and may be composed of at least one of ceramics, diamond-like carbon, colored ink, photoresist and resin, and a part of the second conductive pattern 114 may be optionally disposed on the decoration layer.

The touch display panel of the present invention is not limited to the above-mentioned embodiment. The following description continues to detail the other embodiments or modifications, and in order to simplify and show the difference between the other embodiments or modifications and the above-mentioned embodiment, the same numerals denote the same components in the following description, and the same parts are not detailed redundantly.

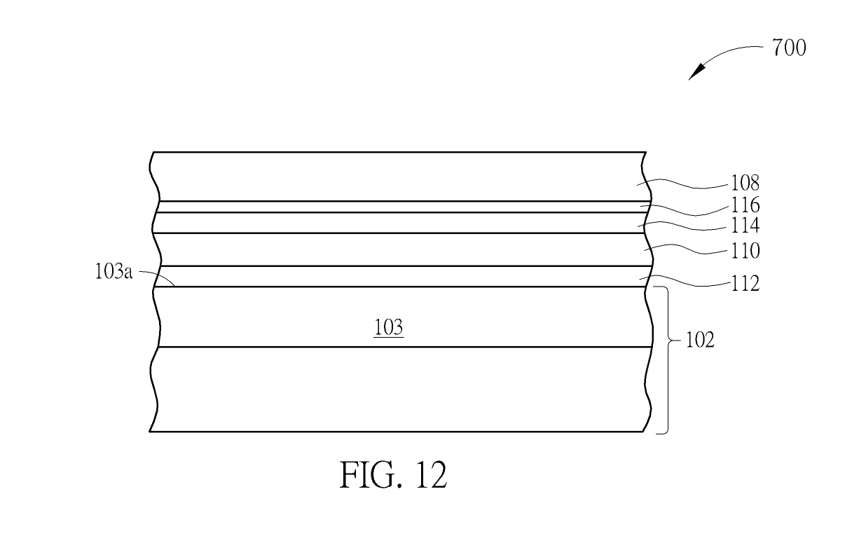

Referring to FIG. 12, FIG. 12 is a schematic diagram illustrating a cross-sectional view of a touch display panel according to a seventh embodiment of the present invention. As shown in FIG. 12, in comparison with first embodiment, the touch display panel 700 of this embodiment may omit the first adhesive layer. In other words, in this embodiment, the display panel 102 includes a top substrate, such as a color filter substrate of the display panel 102, but the present invention is not limited thereto. Furthermore, the first conductive pattern 112, the first insulating layer 110 and the second conductive pattern 114 are sequentially formed on an outer surface 103a of the top substrate 103, so no first adhesive layer is required to combine the first insulating layer 110 with the transparent substrate 108. The transparent substrate 108 is still combined with the second conductive pattern 114 through the second adhesive layer 116.

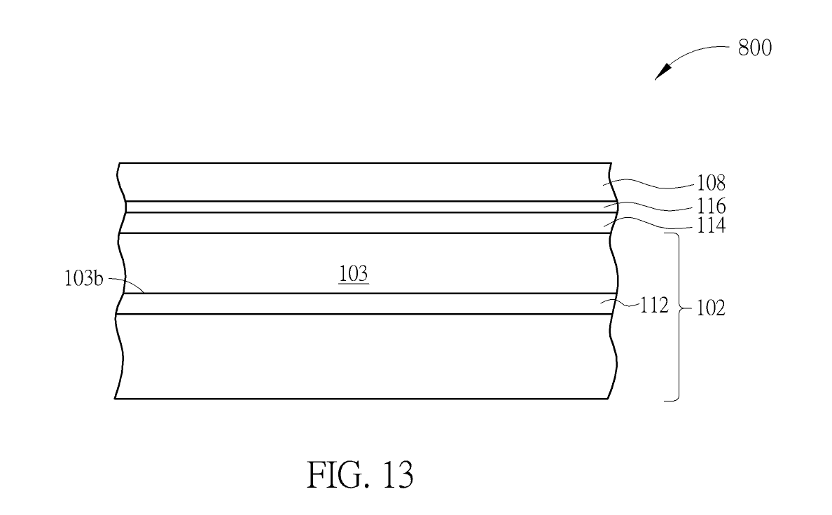

Referring to FIG. 13, FIG. 13 is a schematic diagram illustrating a cross-sectional view of a touch display panel according to an eighth embodiment of the present invention. As shown in FIG. 13, in comparison with seventh embodiment, the touch display panel 800 of this embodiment further omits the first insulating layer. In other words, the first conductive pattern 112 is formed and disposed on an inner surface 103b of the top substrate 103 in this embodiment, so the first conductive pattern 112 is located inside the display panel 102. The second conductive pattern 114 is formed and disposed on the outer surface 103b of the top substrate 103, thereby the first conductive pattern 112 and the second conductive pattern 114 being electrically insulated from each other through the top substrate 103.

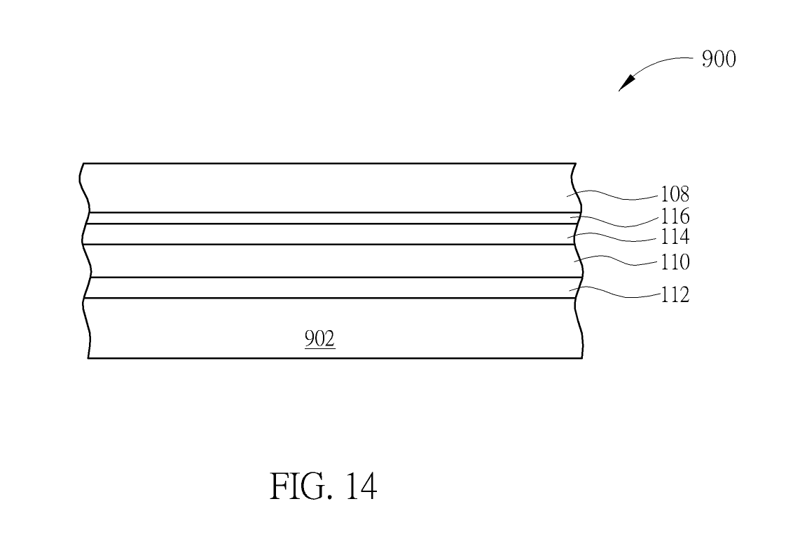

Referring to FIG. 14, FIG. 14 is a schematic diagram illustrating a cross-sectional view of a touch panel according to a ninth embodiment of the present invention. As shown in FIG. 14, in comparison with first embodiment, the touch panel 900 of this embodiment may omit the first adhesive layer and further include a substrate 902. In other words, the first conductive pattern 112, the first insulating layer 110 and the second conductive pattern 114 may be formed sequentially on the substrate 902, and then, the substrate 902 is combined with the transparent substrate 108 through the second adhesive layer 116.

In other embodiments of the present invention, a combination of at least two of the touch panels of the second embodiment, the third through sixth embodiments and the ninth embodiment may be applied to the touch display panel, but the present invention is not limited herein.

In the aforementioned embodiments, the same components in different embodiments with same numerals have the same characteristic, function and material.

As the above-mentioned description, in the touch panel of the present invention, the fringe capacitance between each first electrode strip and each second electrode strip may be increased by increasing the lengths of the sides of each first electrode strip near each second electrode strip or increasing the lengths of the sides of each second electrode strip near each first electrode strip. Also, in the touch panel of the present invention, the shielding patterns are disposed to prevent the second electrode strips from being interfered by the display panel and to compensate the refractive index of the touch panel at the region of the concavities or the openings. Accordingly, the visual difference of the touch panel can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a first insulating layer, having a first side and a second side opposite to each other;
a first conductive pattern, disposed on the first side of the first insulating layer, and the first conductive pattern comprising a plurality of first electrode strips sequentially arranged along a first direction, wherein each first electrode strip comprises a strip portion and a plurality of protrusion portions, the protrusion portions of each first electrode strip are protruded from two sides of each strip portion and along the first direction; and
a second conductive pattern, disposed on the second side of the first insulating layer, and the second conductive pattern comprising a plurality of second electrode strips, wherein the second electrode strips are sequentially arranged along a second direction different from the first direction and cross the first electrode strips.

2. The touch panel according to claim 1, wherein the first conductive pattern further comprises a plurality of shielding patterns, and each shielding pattern is respectively disposed between any two of protrusion portions near each other and at each side of each strip portion, wherein the shielding patterns overlap the second conductive pattern in a third direction perpendicular to the first insulating layer.

3. The touch panel according to claim 2, wherein the protrusion portions of each first electrode strip comprises a plurality of first protrusion portions and a plurality of second protrusion portions, the first protrusion portions and the second protrusion portions are respectively disposed at the two sides of each strip portion and symmetrical to each strip portion in each first electrode strip, and each first protrusion portion and each second protrusion portion form a protrusion pair.

4. The touch panel according to claim 3, wherein the first conductive pattern further comprises a plurality of connecting patterns, and each connecting pattern is connected to the shielding patterns disposed at each side of each strip portion.

5. The touch panel according to claim 4, wherein the shielding patterns are electrically connected to one another.

6. The touch panel according to claim 3, wherein each second electrode strip is disposed between any two of the protrusion portions near each other and protruded from each side of each strip portion.

7. The touch panel according to claim 2, wherein the shielding patterns are electrically floating or connected to a ground.

8. The touch panel according to claim 1, further comprising a transparent substrate disposed on the second conductive pattern and the second side of the first insulating layer.

9. The touch panel according to claim 8, further comprising an adhesive layer disposed between the transparent substrate and the second conductive pattern.

10. The touch panel according to claim 8, further comprising an adhesive layer disposed between the second conductive pattern and the first insulating layer.

11. The touch panel according to claim 8, further comprising a second insulating layer disposed between the second conductive pattern and the transparent substrate.

12. The touch panel according to claim 11, further comprising two adhesive layers, disposed between the transparent substrate and the second insulating layer and between the second conductive pattern and the first insulating layer respectively.

13. A touch display panel, comprising:
a touch panel, comprising:
a first insulating layer having a first side and a second side opposite to each other;
a first conductive pattern disposed on the first side of the first insulating layer, and the first conductive pattern comprising a plurality of first electrode strips sequentially arranged along a first direction and a plurality of shielding patterns, wherein each first electrode strip comprises a strip portion and a plurality of protrusion portions, the protrusion portions of each first electrode strip are protruded from two sides of each strip portion and along the first direction, and each shielding pattern is respectively disposed between any two of the protrusion portions near each other and at each side of each strip portion; and
a second conductive pattern disposed on the second side of the first insulating layer, and the second conductive pattern comprising a plurality of second electrode strips, wherein the second electrode strips are arranged along a second direction different from the first direction and cross the first electrode strips, and the shielding patterns overlap the second conductive pattern in a third direction perpendicular to the first insulating layer; and
a display panel disposed at one side of the touch panel.

14. A touch display panel, comprising:
a display panel, comprising a top substrate and a first conductive pattern, wherein the top substrate has an outer surface and an inner surface, the first conductive pattern is disposed on the inner surface of the top substrate, and the first conductive pattern comprises a plurality of first electrode strips sequentially arranged along a first direction, and a plurality of shielding patterns, wherein each first electrode strip comprises a strip portion and a plurality of protrusion portions, the protrusion portions of each first electrode strip are protruded from two sides of each strip portion and along the first direction respectively, and each shielding pattern is disposed between any two of the protrusion portions near each other and at each side of each strip portion; and
a second conductive pattern disposed on the outer surface of the top substrate, and the second conductive pattern comprising a plurality of second electrode strips, wherein the second electrode strips are sequentially arranged along a second direction different from the first direction and cross the first electrode strips, and the shielding patterns overlap the second conductive pattern in a third direction perpendicular to the first insulating layer.

15. A touch panel, comprising:
a first insulating layer, having a first side and a second side opposite to each other;
a first conductive pattern, disposed on the first side of the first insulating layer, and the first conductive pattern comprising a plurality of first electrode strips sequentially arranged along a first direction, wherein each first electrode strip comprises a plurality of openings arranged in a matrix formation; and
a second conductive pattern, disposed on the second side of the first insulating layer, and the second conductive pattern comprising a plurality of second electrode strips, wherein the second electrode strips are arranged along a second direction different from the first direction and cross the first electrode strips.

16. The touch panel according to claim 15, wherein the first conductive pattern further comprises a plurality of shielding patterns, and each shielding pattern is disposed in each opening respectively, wherein the shielding patterns overlap the second conductive pattern in a third direction perpendicular to the first insulating layer.

17. The touch panel according to claim 16, wherein each second electrode strip comprises a strip portion and a plurality of protrusion portions, and the protrusion portions of each second electrode strip extend from two sides of each strip portion.

18. The touch panel according to claim 17, wherein each strip portion cross the openings in a same column.

19. The touch panel according to claim 17, wherein the protrusion portions overlap the shielding patterns respectively.

20. The touch panel according to claim 17, wherein the strip portion and the protrusion portions of each second electrode strip form a plurality of palisade-shaped structures, and each palisade-shaped structure of each second electrode strip is disposed corresponding to each first electrode strip.

21. The touch panel according to claim 16, wherein the shielding patterns are electrically floating or connected to a ground.

22. The touch panel according to claim 15, further comprising a transparent substrate disposed on the second conductive pattern and the second side of the first insulating layer.

23. The touch panel according to claim 22, further comprising an adhesive layer disposed between the transparent substrate and the second conductive pattern.

24. The touch panel according to claim 22, further comprising an adhesive layer disposed between the second conductive pattern and the first insulating layer.

25. The touch panel according to claim 22, further comprising a second insulating layer disposed between the second conductive pattern and the transparent substrate.

26. The touch panel according to claim 25, further comprising two adhesive layers, disposed between the transparent substrate and the second insulating layer and between the second conductive pattern and the first insulating layer respectively.

27. A touch display panel, comprising:
a touch panel, comprising:
a first insulating layer, having a first side and a second side opposite to each other;
a first conductive pattern, disposed on the first side of the first insulating layer, and the first conductive pattern comprising a plurality of first electrode strips sequentially arranged along a first direction, and a plurality of shielding patterns, wherein each first electrode strip comprises a plurality of openings arranged in a matrix formation, and each shielding pattern is disposed in each opening respectively; and
a second conductive pattern, disposed on the second side of the first insulating layer, and the second conductive pattern comprising a plurality of second electrode strips, wherein the second electrode strips are sequentially arranged along a second direction different from the first direction and cross the first electrode strips, and the shielding patterns overlap the second conductive pattern in a third direction perpendicular to the first insulating layer; and
a display panel, disposed at one side of the touch panel.

28. A touch display panel, comprising:
a display panel, comprising a top substrate and a first conductive pattern, wherein the top substrate has an outer surface and an inner surface, the first conductive pattern is disposed on the inner surface of the top substrate, and the first conductive pattern comprises a plurality of first electrode strips sequentially arranged along a first direction and a plurality of shielding patterns, wherein each first electrode strip comprises a plurality of openings arranged in a matrix formation, and each shielding pattern is disposed in each opening respectively; and
a second conductive pattern, disposed on the outer surface of the top substrate, and the second conductive pattern comprising a plurality of second electrode strips, wherein the second electrode strips are sequentially arranged along a second direction different from the first direction and cross the first electrode strips, and the shielding patterns overlap the second conductive pattern in a third direction perpendicular to the first insulating layer.
